(19) United States
(12) Patent Application Publication
(10) Pub. No.: US 2012/0328793 A1
(43) Pub. Date: Dec. 27, 2012

(54) THERMAL SPRAY SYNTHESIS OF SUPERCAPACITOR AND BATTERY COMPONENTS

(75) Inventors: Ramesh K. Guduru, Canton, MI (US); Pravansu S. Mohanty, Canton, MI (US)

(73) Assignee: MRIDANGAM RESEARCH INTELLECTUAL PROPERTY TRUST, Canton, MI (US)

(21) Appl. No.: 13/312,042

(22) Filed: Dec. 6, 2011

Related U.S. Application Data
(60) Provisional application No. 61/420,930, filed on Dec. 8, 2010.

(51) Int. Cl. H01G 13/00; H01M 10/04

(52) U.S. Cl. 427/446

(57) ABSTRACT

A method of fabricating an ultracapacitor/supercapacitor or Li-ion battery components from a solid/liquid/gaseous precursor and thermal spray depositing the precursor on a substrate to form a coating layer such that the at least one component is synthesized or pre-synthesized within the thermal spray prior to or after being deposited on the substrate.

### CROSS-REFERENCE TO RELATED APPLICATIONS

This application claims the benefit of U.S. Provisional Application No. 61/420,930, filed on Dec. 8, 2010. The entire disclosures of the above applications are incorporated herein by reference.

### FIELD

The present disclosure relates to manufacturing of components for supercapacitors/ultracapacitors and Li-ion batteries, more particularly, relates to deposition apparatus, schemes and recipes for synthesis of electrode materials and components using thermal spray processes in combination with or without subsequent thermal treatment for microstructural modification.

### BACKGROUND

This section provides background information related to the present disclosure which is not necessarily prior art.

Supercapacitors/ultracapacitors are known for their high power density and at the same time relatively high energy density.

Supercapacitors/ultracapacitors exhibit enhanced capacitance over the conventional and electrolytic capacitors because of their non-faradic double layer capacitance as well as faradic pseudo capacitance.

Similarly Li-ion batteries are known for their high energy density for energy storage applications.

Batteries and supercapacitors have many applications in automobiles, electronics, biomedical systems, aerospace systems and other personal applications.

With increasing global demand for alternative energy sources and green technologies there is a considerable requirement for the inexpensive materials and manufacturing technologies. For the past couple of decades different researchers have focused on developing electrodes and solid electrolytes with inexpensive materials while controlling the chemistry, microstructure and particulate size to obtain better performance with enhanced energy or charge storage capacitance.

With particular reference to FIG. 1, supercapacitors/ultracapacitors as well as Li-ion batteries typically comprise of two electrodes, a separator, and an electrolyte. Different materials are being tested for these components in the industry. For example, material chemistries such as oxides of rare earth metals (eg: RuO₂, IrO₂) and transition metals (eg: Co₃O₄, MnO₂) etc. for electrodes in capacitors, and transition metal oxides and layer structured Lithium metal oxide compounds (eg: LiCoO₂) for battery electrode applications. The electrolytes in capacitors can be either liquid (eg: aqueous KOH, NaOH, nonaqueous) or solid (NiO, Tungsten Oxide etc.) or a combination thereof. The separators are typically porous membranes.

Nanostructured and porous electrodes are also of great interest as they enhance total surface area of the electrodes and thereby total energy storage and capacitance.

There are various techniques available to make the electrodes; namely vapor deposition techniques, powder processing routes, wet chemical methods and electrochemical deposition techniques. But these techniques are either expensive or time consuming with multi-step processes for developing capacitors and battery electrodes with liquid/solid electrolytes, as shown in FIG. 2A.

Therefore, there is a great need as well as an opportunity for the development of a less time consuming and industrially scalable manufacturing technology with least number of processing steps.

### SUMMARY

This section provides a general summary of the disclosure, and is not a comprehensive disclosure of its full scope or all of its features.

This present disclosure provide for schemes, apparatus and recipes comprising the use of appropriate precursors for supercapacitor/ultracapacitor and Li-ion battery materials which are injected into a hot flame for chemical/thermal treatment and then consolidation into the desired component layers of a supercapacitor/ultracapacitor or a Li-ion battery components on the current collector substrate. The spray/deposition process utilizes precursors in the form of powders/liquids/gases or a combination thereof to obtain different material combinations needed for supercapacitor/ultracapacitor and battery components. If desired, a heat source, such as a laser beam or a heat source or a plasma plume are also used for an in-situ heat treatment or ex-situ heat treatment of the deposited materials for microstructures and phase control required for optimum performance of the supercapacitor/ultracapacitor and Li-ion batteries. This approach offers several advantages in terms of reduced number of process steps, geometric freedom and scalability of the method to large area electrode manufacturing and therefore practicable for industrial scale production.

In some embodiments of this disclosure, the components such as current collectors, electrodes, electrolytes and separator membranes and/or their combination can be manufactured based on the principles of the current teachings, which enables layer by layer fabrication of all the components of the entire capacitor or battery. Thus, complex supercapacitor/ultracapacitor and battery configurations can be achieved where the synthesis of the material and the assembly of the cell are performed in-line.

Other areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. For purposes of clarity, not every component is labeled in every figure, nor is every component of each embodiment of the disclosure shown.

FIG. 1 is a schematic illustration of a supercapacitor/ultracapacitor or a Li-ion battery components

FIG. 2A is a schematic flowchart illustrating a multi-step conventional approach for making a supercapacitor/ultracapacitor or a Li-ion battery component

FIGS. 2B and 2C are a schematic flowchart illustrating synthesis of a supercapacitor/ultracapacitor or a battery component according to the present teachings;

FIG. 3 is a schematic of an exemplary embodiment for the spray device comprising a streamed directional heat source with flame, and a reservoir with liquid/solid/gaseous precursors;

FIG. 4 is a schematic of an exemplary supercapacitor or battery component synthesized from the liquid/gaseous/solid precursors according to the principles of the current teachings, the zoom in view is showing a variety of microstructures with different surface morphological patterns;

FIG. 5 is a TEM image for an exemplary anode component for a Li-ion battery or an electrode component for supercapacitor synthesized from solution precursors according to the principles of the current teachings;

FIG. 6 is an XRD pattern for an exemplary electrode film synthesized directly from liquid precursors for supercapacitors or Li-ion battery anodes according to the principles of the current teachings;

FIG. 7 is an exemplary cyclic voltammetry in three electrode mode for a transition metal oxide electrode fabricated directly from liquid/solid/gaseous precursors according to the principles of the current teachings;

FIG. 8 is an exemplary cyclic voltammetry in two electrode mode for a transition metal oxide electrode fabricated directly from liquid/solid/gaseous precursors according to the principles of the current teachings;

FIG. 9 is an exemplary impedance for a capacitor fabricated directly from liquid/solid/gaseous precursors according to the principles of the current teachings;

FIG. 10 is an exemplary charge-discharge cycling for a capacitor fabricated directly from liquid precursors according to the principles of the current teachings;

FIG. 11 is a TEM image for an exemplary cathode component synthesized for a Li-ion battery from powder precursors according to the principles of the current teachings;

FIG. 12 is an exemplary XRD pattern for a cathode film developed for Li-ion batteries from powder precursors according to the principles of current teachings;

FIG. 13 is an exemplary charge-discharge cycling for a Li-ion battery cathode fabricated from powder precursors according to the principle of the current teachings

FIG. 14 is an exemplary charge-discharge cycling for a Li-ion battery Co₃O₄ anode fabricated from solution precursors according to the principle of the current teachings

FIG. 15 is an exemplary charge-discharge cycling for a Li-ion battery Manganese oxide anode fabricated from powder precursors according to the principle of the current teachings

FIG. 16 is a schematic of a system illustrating roll-to-roll fabrication of component layers comprising multiple deposition systems;

FIG. 17 is a TEM image of an exemplary solid state electrolyte layer for a supercapacitor fabricated according to the principles of the current teachings;

FIG. 18 is a perspective view of an exemplary capacitor manufactured layer by layer according to the principles of the current teachings;

FIG. 19 is a perspective view of an exemplary capacitor being deposited layer by layer on a submarine according to the principles of the current teachings;

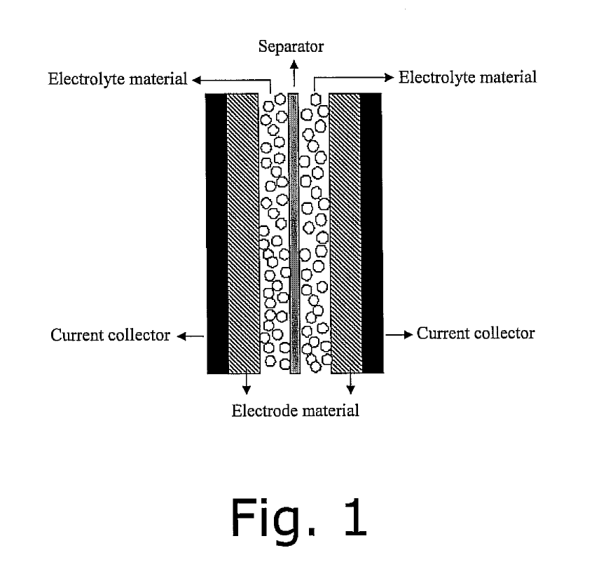

Corresponding reference numerals indicate corresponding parts throughout the several views of the drawings.

### DETAILED DESCRIPTION

Non-limiting embodiments of the present disclosure will be described by way of example with reference to the accompanying figures, which are schematic and are not intended to be drawn to scale.

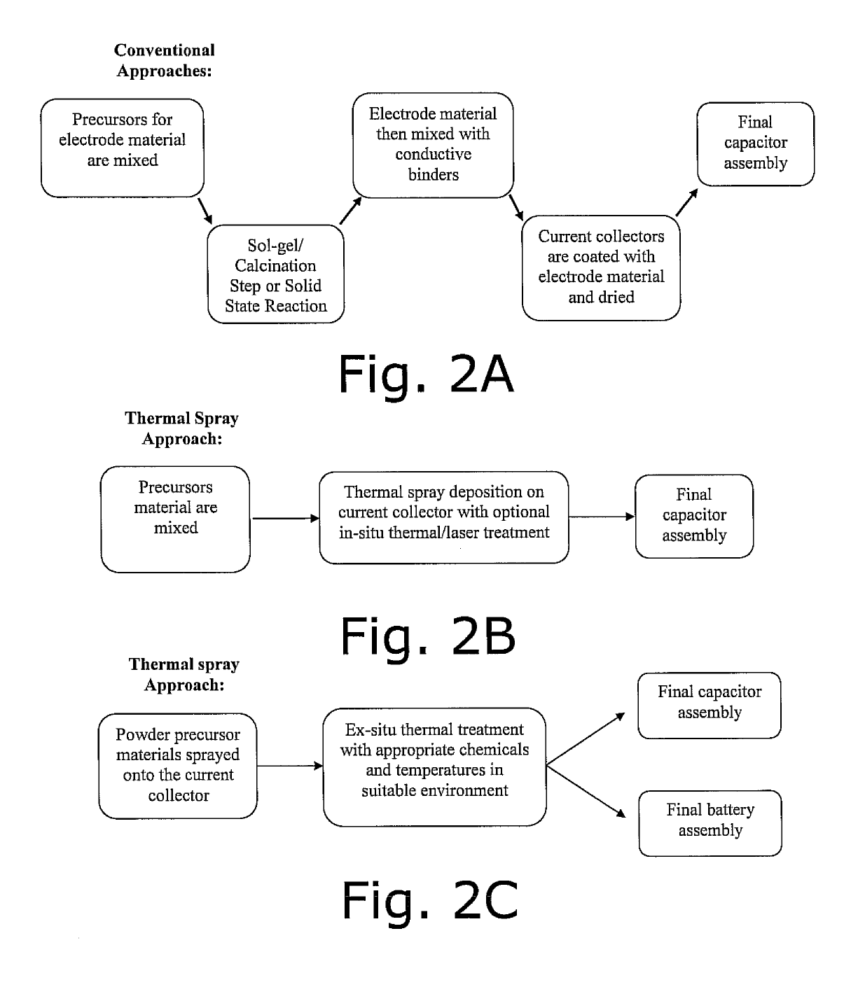

As shown in FIG. 2A, current practices for the preparation of supercapacitor/ultracapacitor or Li-ion battery electrodes involve many process steps and require several hours of processing time. New strategies for the synthesis of electrodes or other components of the supercapacitors and batteries with reduced processing time and simultaneously offer adequate control over material chemistry and morphology are of critical importance.

As shown in FIG. 2B, the current teachings provide manufacturing schemes to fabricate the electrodes and/or other components using an appropriate fluids or solid precursors which are injected to a stream of high temperature plume for chemical/thermal treatment and consolidation into the desired active layer of the electrode assembly. The fluid precursors upon injection into the hot plume undergo thermo-chemical conversion resulting in fine molten/semi-molten/solid droplets of the desired materials that are consolidated into a film form. Further, when necessary, a heat source provides for in-situ or ex-situ heat treatment of the film with appropriate conditions, such as chemicals, environment, and temperatures to optimize the chemistry, phase and morphology for enhanced supercapacitor and battery performance.

The manufacturing schemes of the present disclosure provide supercapacitor or battery component films possessing the desired microstructures, morphological features, phase and compositions from chemical and powder precursors, and thus, eliminate processing steps currently practiced in the industry. The spray deposition techniques of the current teachings also enable creation of supercapacitor or battery components on geometrically complex shapes. Spray synthesis of supercapacitor or battery components with or without in-situ or ex-situ thermal treatments can be performed under desired atmosphere (e.g. N₂ or N₂/H₂ or O₂ or Ar) according to the current scheme. In some embodiments, the use of fluid precursors ensure homogeneity of component elements and increase the reaction rates during synthesis compared to the solid state reactions commonly practiced in conventional processes, and thus can reduce the processing time.

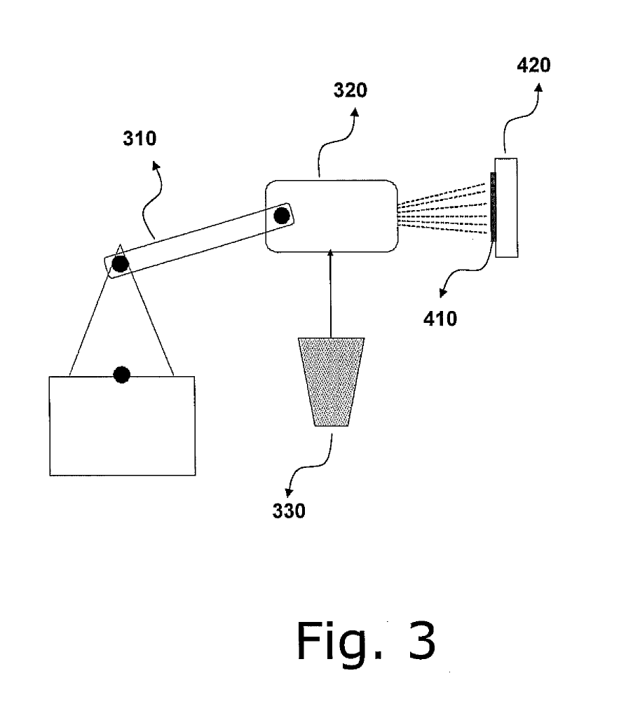

In FIG. 3, the fabrication apparatus assembly 300 comprises a motion system 310 that mechanically moves the spray device 320 to build a uniform layer 410 on the substrate or target 420, utilizing the fluid or powder precursors from a reservoir 330 in measured quantities via a pumping system. The apparatus assembly 300 can be installed in an inert environment.

Referring to FIG. 3, in some embodiments, the spray device 320 can comprise a plasma gun with powder or fluid precursor injection element, and in case of fluid precursors the embodiments can also have atomizer. Using this approach, multiple precursors can be efficiently incorporated into the plasma stream; however, it is not necessary to employ all the injection elements at a given time. The plasma is generated in the gun according to the principles of direct current plasma or DC plasma as commonly known in the literature.

The spray device 320, as shown in FIG. 3, can also be provided with a heat source that is capable of treating the deposited material in-situ simultaneously as the layers are deposited by plasma stream on the substrate. The energy source can be a laser, plasma, radiation or a convection heat source.

The supercapacitor or battery component films obtained according to the principles of the current teachings may or may not contain any polymer binder or additives like conventional electrodes/components used in the industry. The polymer binderless electrodes can operate at higher temperature. However, it is also possible to incorporate polymer binders, if required, in the spray deposited components of supercapacitors and batteries according to the principles of the current teachings.

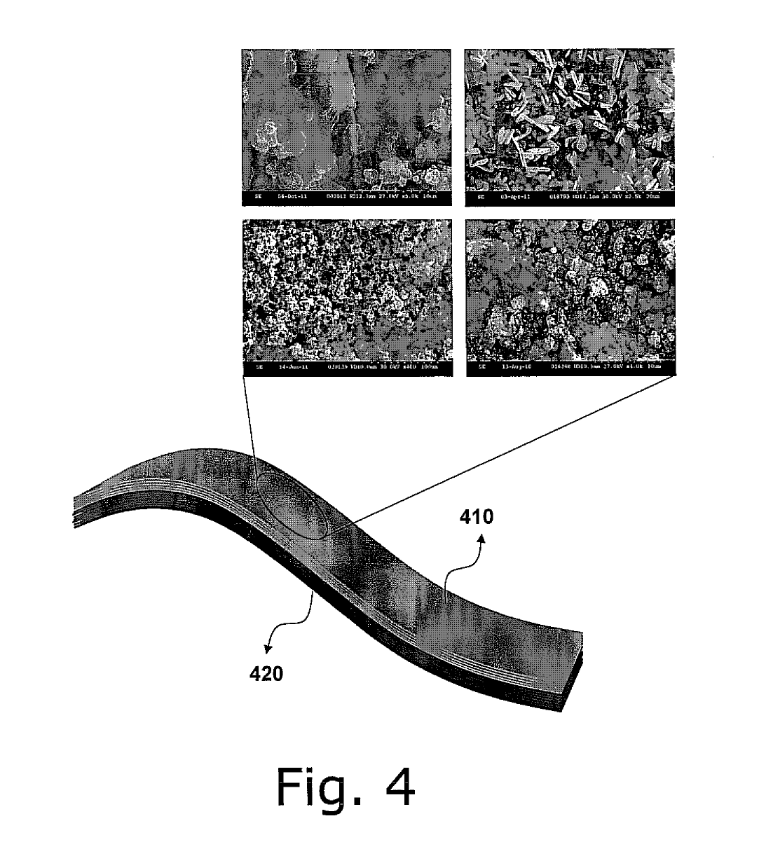

FIG. 4 shows the electrode film 410 deposited from a solid/liquid/gaseous precursor according to the current teachings with different microstructures and surface morphologies on a current collector or substrate 420.

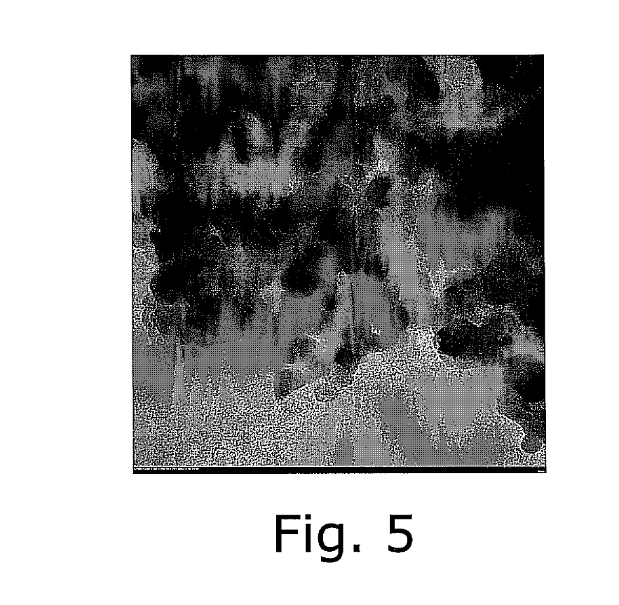

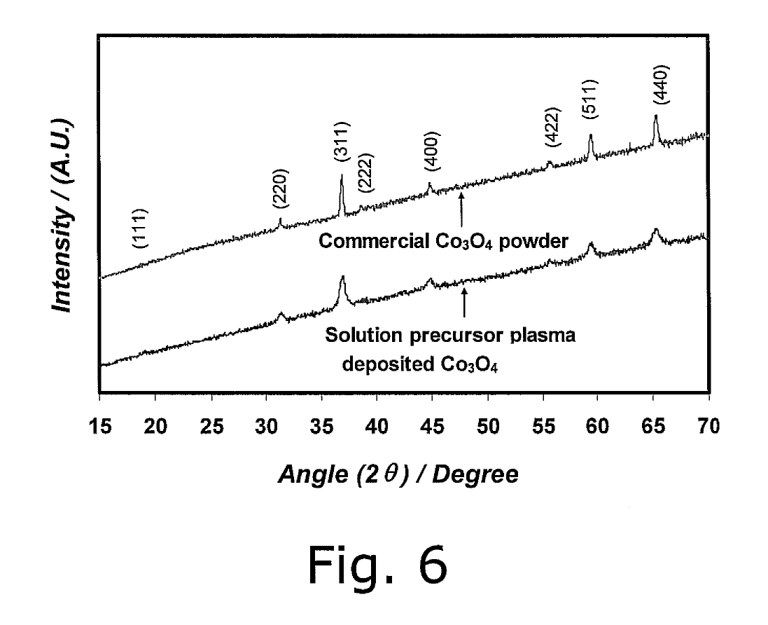

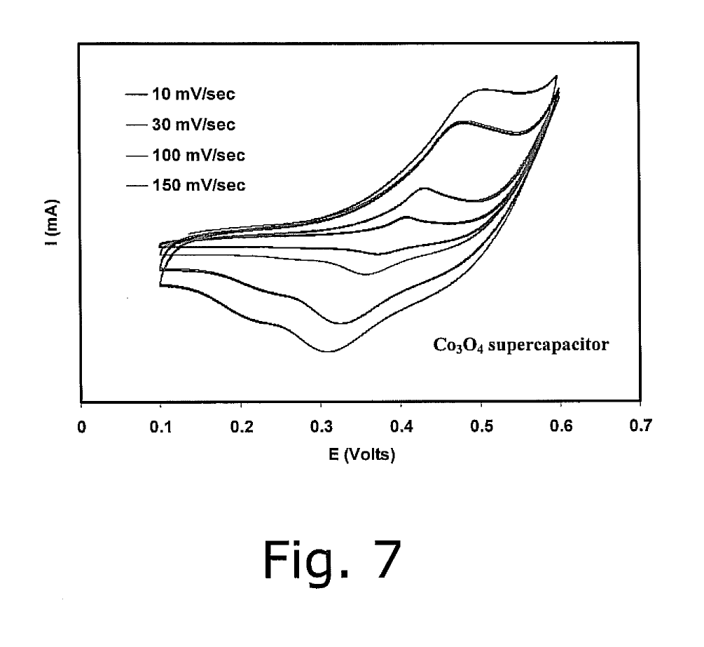

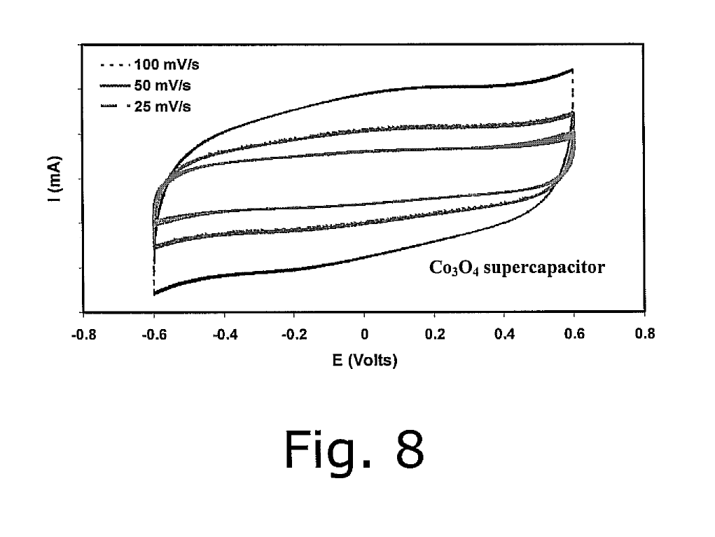

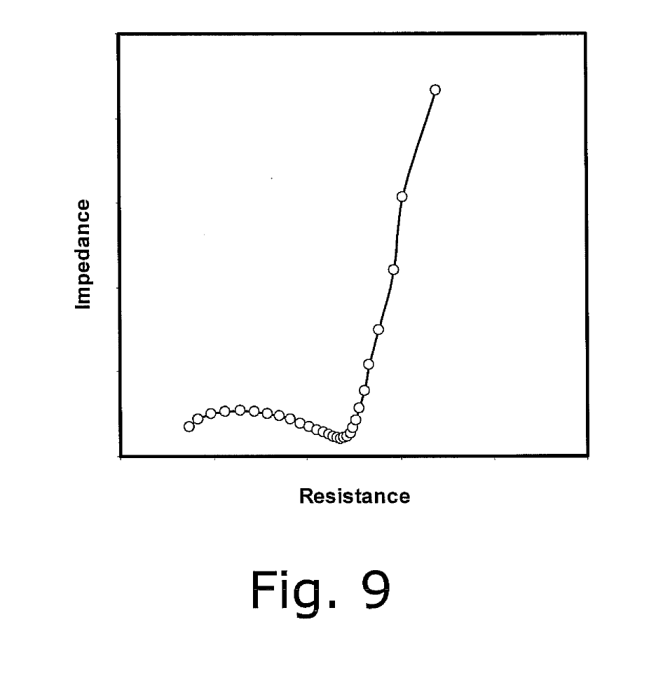

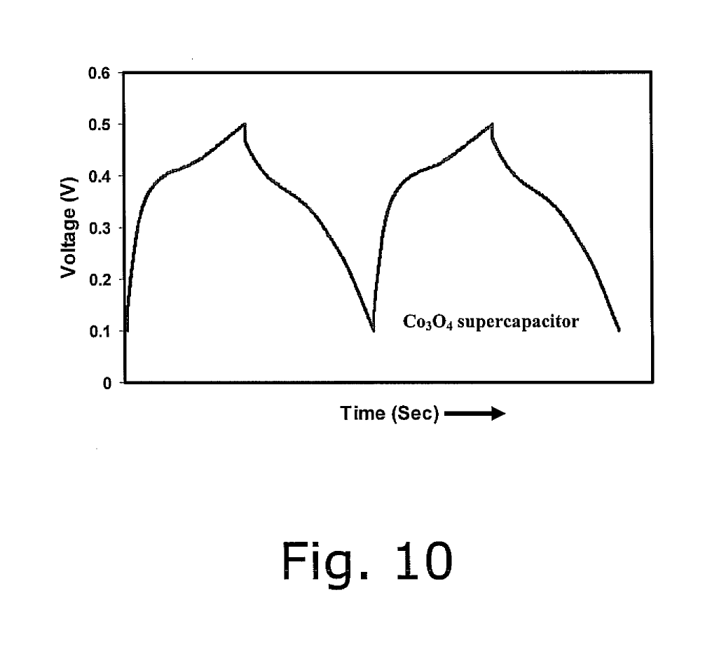

FIG. 5 illustrates the TEM picture of the film, showing nanostructured particulates of Co₃O₄ electrode film 410 developed from a solution precursor. Further the XRD shown in FIG. 6 confirms the Co₃O₄ phase in the electrode film 410. The electrode with nanostructure and porosity are very much desired for the supercapacitor or battery electrodes and thus the principles set forth herein can successfully create the desired electrode directly eliminating intermediate processing steps commonly adopted in industrial practice. Further, the cyclic voltammetry in three and two electrode configurations, impedance as well as cyclic charge and discharge capacity of thus obtained electrode films are illustrated in FIGS. 7, 8, 9 and 10, respectively, which further support the claims of the current teachings.

An exemplary precursor for Co₃O₄ electrode comprises water and Co-nitrate in a pH adjusted solution. Further, additives can be added, if required in the solution for doping. The resulting molten/semi-molten Co₃O₄ particles are deposited as a film 410 onto a current collector 420 such as an aluminum foil as illustrated in FIG. 4 by utilizing a plasma device 310 of FIG. 3. The solution precursor is successfully pyrolized and deposited onto the substrates in open atmosphere resulting in fine particulates of Co₃O₄. Carbon can also be added to the film via gaseous or fluid or solution or solid precursors 330 as described in the current teachings. In some embodiments, the film can also be obtained following the principles of the current teachings by employing the liquid precursors described herein and the combustion devices. The choice between plasma or combustion flame depends on the desired density and particulates in the film.

An exemplary and non-limiting variation to directly fabricate the electrode film according to the principles of the current teachings starts with the deposition of a metallic cobalt film employing a plasma device 310 of FIG. 3 and solid powder precursor of cobalt followed by in-situ or ex-situ thermal treatment. A Co₃O₄ electrode film develops directly on the current collector 420 following these teachings.

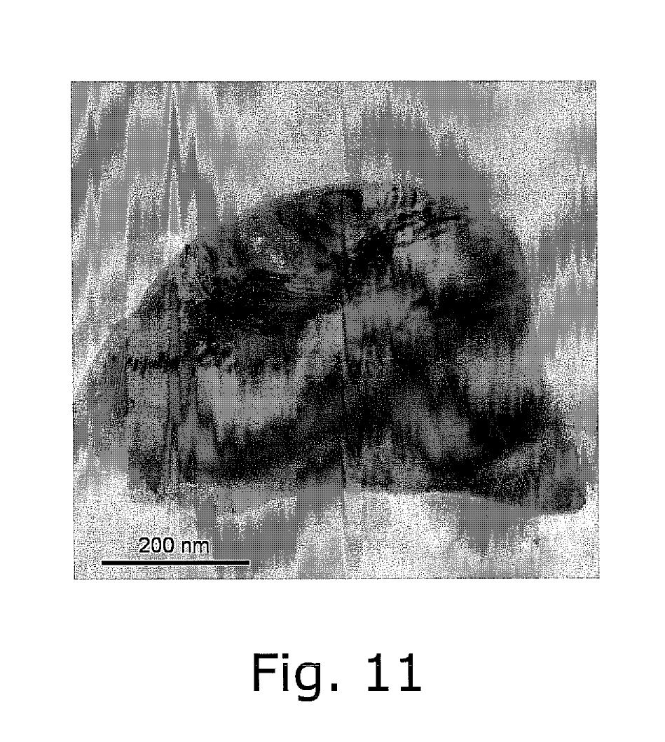

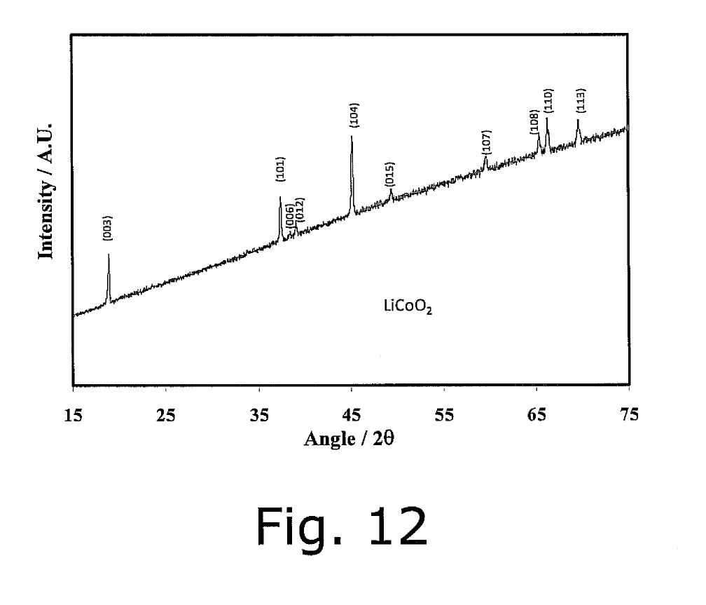

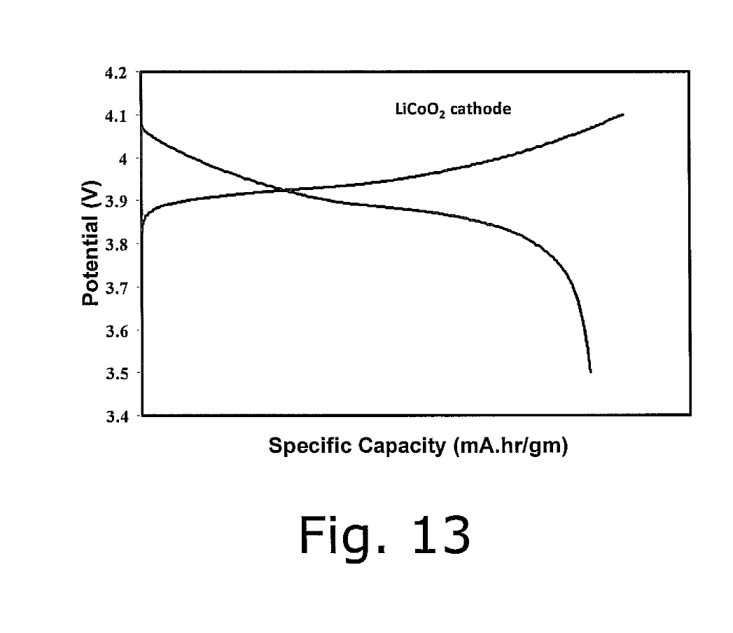

FIG. 11 illustrates a TEM picture of the cathode material, showing nanostructured platelet of LiCoO₂ electrode developed with ex-situ heat treatment of metallic Co film 410 obtained from powder precursors. The XRD pattern shown in FIG. 12 confirms the LiCoO₂ phase in the electrode. These electrodes with nanostructure are very much desired for the Li-ion battery applications. Further, the charge and discharge cycles shown in FIG. 13 support the claims of the current teachings.

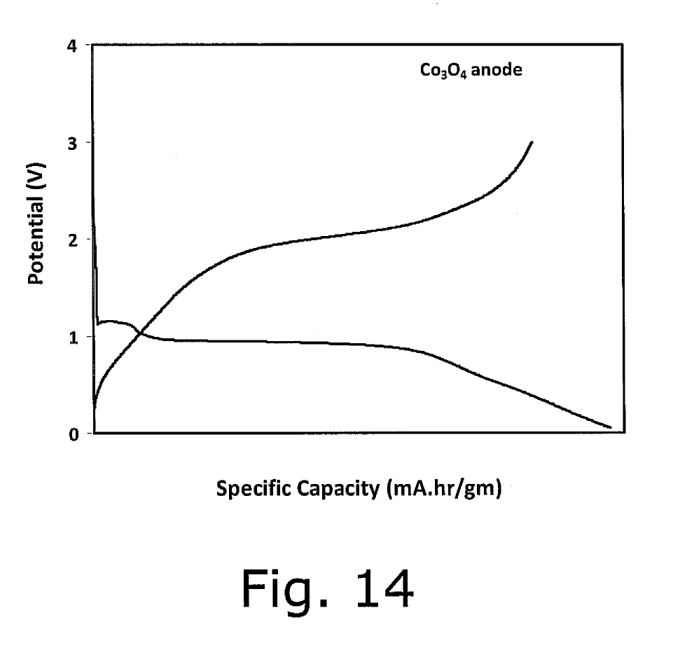

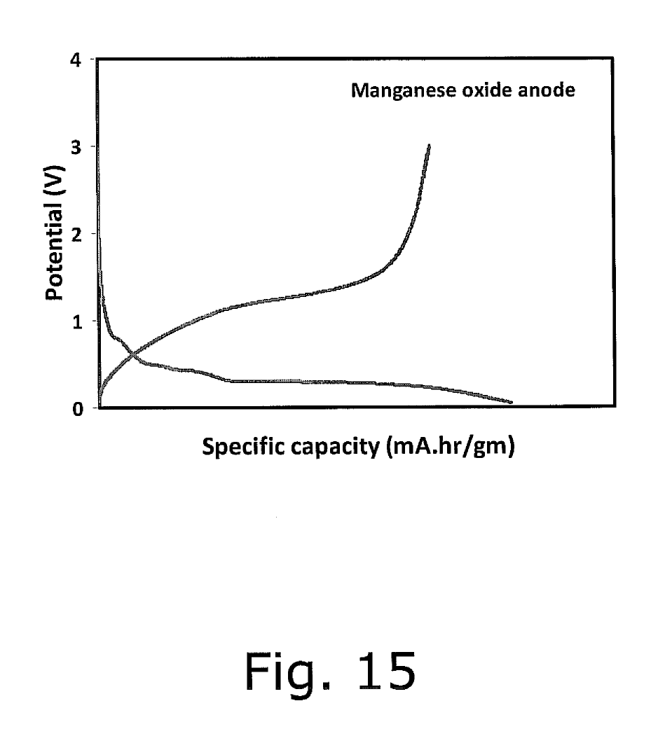

FIGS. 14 and 15 illustrate charge and discharge cycles of Co₃O₄ and manganese anode films fabricated from solution and powder precursors, respectively, for Li-ion battery applications according to the principles of current teachings.

The benefits of thermal spray process include large throughputs and porous coatings, which provide large surface area for faster reaction/oxidation kinetics in the next step, i.e., in-situ or ex-situ desired oxidation/heat treatment process. Further, the transition metals, such as Co, Ni and Mn sheet metals are expensive compared to their powders (powders are often the end product of their extraction processes, e.g. electrowinning of Mn), and plasma deposition uses the powder precursor. Accordingly, the reaction kinetics are much faster in the plasma sprayed porous coatings compared to the bulk sheet metals. Often oxide scales developed on the bulk metal flake off due to the strain associated with volume change while the plasma sprayed porous coating can accommodate the strain and stay adherent to the substrate. Thus, nanostructured films with superior charge/discharge cyclability and specific capacity can be manufactured cost effectively. Additionally, the absence of polymers or binders can make these electrodes suitable for high temperature supercapacitor and battery applications.

Exemplary electrode films described herein are for illustration purposes only and were obtained according to the principles of the current teachings, and they do not intend to limit the full scope of the possible material systems that can be synthesized following the principles of the present disclosure.

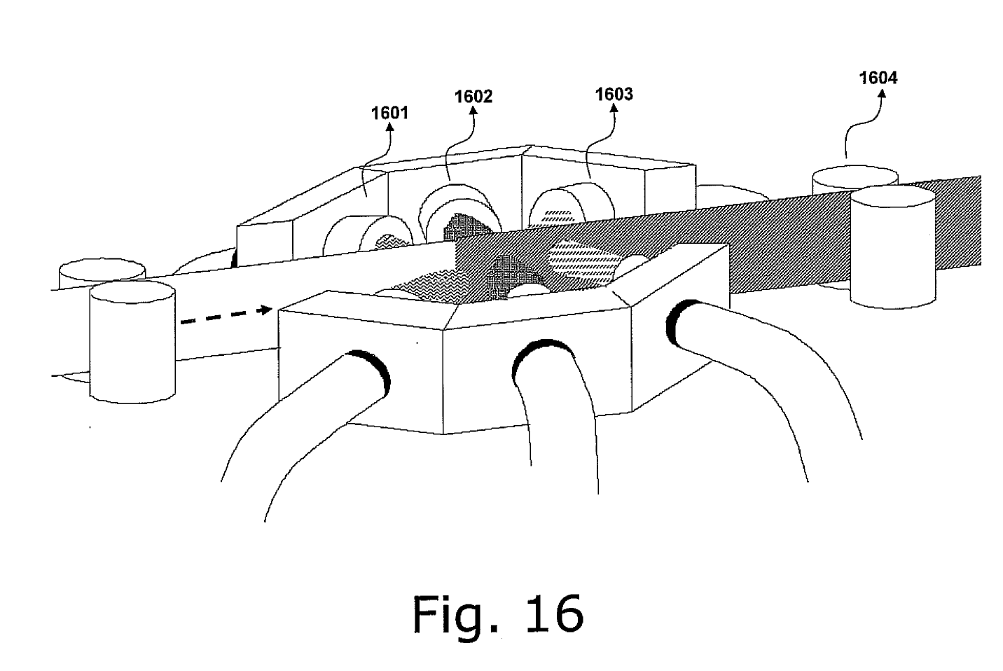

In some embodiments of the current disclosure, multiple spray devices can be employed to deposit the supercapacitor or battery component materials on both sides of the current collector according to the principles of the current teachings in a roll to roll manufacturing configuration 1600 as illustrated in FIG. 16. In this embodiment, the spray device systems 1601, 1602, and 1603 contribute the synthesized materials. Further, the rolls 1604 can compress the films after in-situ treatment to control the porosity structure of the electrode material. Such embodiment can be adopted for both cathode and anode leading to an industrial battery assembly process, where the separator and electrolyte layers are incorporated forming the entire cell.

Solid electrolytes are well suited for battery and supercapacitor operations at various temperatures, including high temperatures. Further they provide a safer operating environment. Most of the solid electrolytes are synthesized through solid state or sol-gel methods and the glassy phase is achieved through rapid quenching from the high temperature annealed state.

According to the principles of direct synthesis from precursors set forth herein, appropriate liquid/solid precursors are introduced into plasma device 320 of FIG. 3 to synthesize the solid state electrolyte films on the electrodes with desired material chemistry, phase and morphology. This capability facilitates the fabrication of monolithic layers wherein the active electrode and solid electrolyte can both be deposited using the plasma spray device sequentially, thus reducing process steps and cost of manufacturing battery cells.

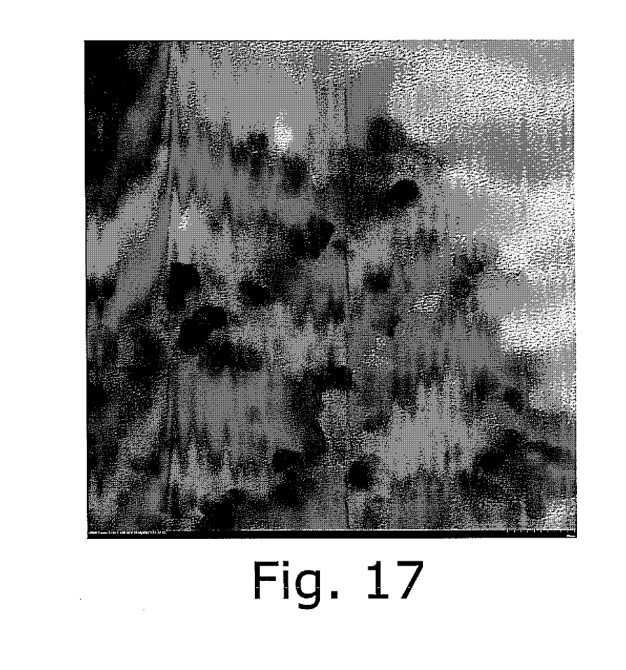

To this end, an exemplary solid electrolyte based on NiO using solid and liquid precursors was directly synthesized according to the principles of the current teachings. The exemplary solution precursor is comprised of Ni-nitrate or Ni-acetate, The TEM image of deposited NiO film described here is shown in FIG. 17.

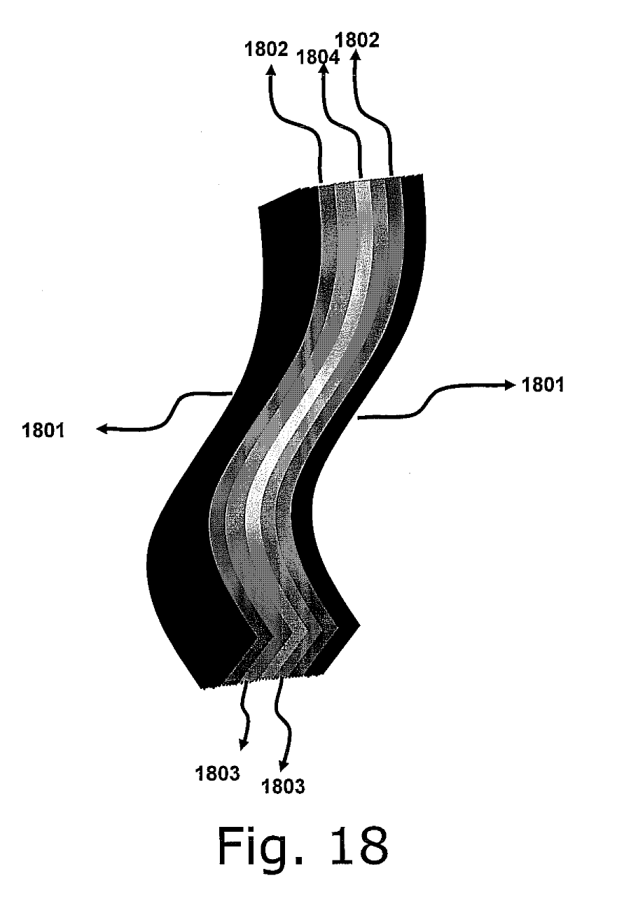

According to the present disclosure, fabrication of electrodes and solid electrolytes sequentially, offers an advantage to build monolithic supercapacitors or batteries. As shown in exemplary embodiments 1800 in FIG. 18, the entire supercapacitor cell comprising current collector 1801, electrodes 1802, electrolyte 1803, an optional separator 1804 and the second current collector 1805, which can be sequentially built into a flexible monolithic structure. The current collectors can be built using solid precursor powders of conductive metals such as Al, Cu, or stainless steel by the plasma spray device. This ability provides tremendous geometric and functional capability to the manufacturing technique demonstrated here.

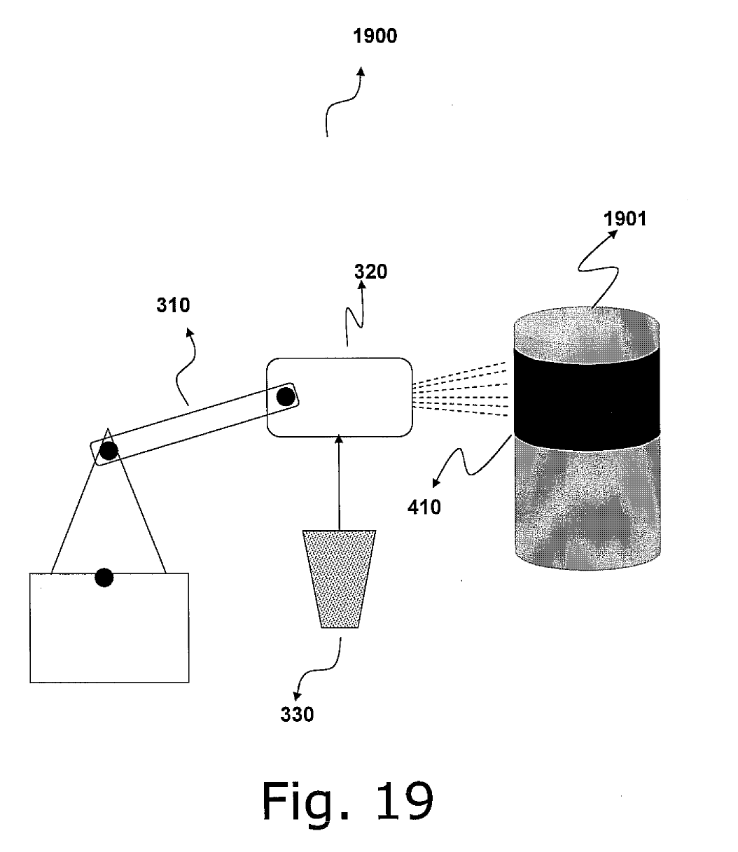

Referring to FIG. 19, conformal supercapacitor/ultracapacitor or Li-ion battery 1900 can be built onto complex shapes such as cylindrical shapes according to the principles of the current teachings. The capabilities of current teachings can be extended to aerospace bodies, space crafts, space stations, satellites, solar cells, automobile bodies, submarines and ships. With the geometric freedom possible as described here, the structures or bodies of any kind with power requirement can be designed according to functional and styling needs and the supercapacitor/ultracapacitor or battery can be fabricated to be accommodated in the available space.

Exemplary configurations described herein are for illustration purposes only and they do not intend to limit the full scope of the possible configurations and combinations that can be achieved following the principles of the present disclosure. The principles of current teachings can be applied for individual components such as the electrodes or electrolytes or the separator or any combination thereof.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, Layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method of fabricating an/a ultracapacitor/supercapacitor member from a precursor, said method comprising:
providing a precursor having at least one component dissolved in said precursor; and thermal spray depositing said precursor on a substrate to form a coating layer such that said at least one component is synthesized within said thermal spray prior to being deposited on said substrate.

2. A method of fabricating an/a ultracapacitor/supercapacitor or Li-ion battery member from a precursor, said method comprising:
providing a precursor having at least one powder or suspension component in said precursor; and thermal spray depositing said precursor on a substrate to form a coating layer such that said at least a pre-component or part of the component is synthesized within said thermal spray prior to being deposited on said substrate.

3. The method according to claim 1 wherein said providing a precursor having at least one component dissolved in said precursor comprises providing a precursor having at least one component chemically dissolved in said precursor solution.

4. The method according to claim 1, further comprising: heat treating said coating layer to achieve a predetermined chemistry, microstructure, phase, or morphology.

5. The method according to claim 4 wherein said heat treating said coating layer comprises heat treating said coating using a laser source.

6. The method according to claim 4 wherein said heat treating said coating layer comprises heat treating said coating using a plasma source.

7. The method according to claim 4 wherein said heat treating said coating layer comprises heat treating said coating using a combustion flame.

8. The method according to claim 4 wherein said heat treating said coating layer comprises heat treating said coating using a furnace.

9. The method according to claim 4 wherein said heat treating said coating layer comprises heat treating said coating using induction heating.

10. The method according to claim 1 wherein said heat treating is at least partially completed prior to deposition of a coating layer and/or a subsequent coating layer.

11. The method according to claim 1 wherein said providing a precursor having at least one compound dissolved in said precursor comprises providing a liquid precursor.

12. The method according to claim 1 wherein said providing a precursor having at least one compound dissolved in said precursor comprises providing a gaseous precursor.

13. The method according to claim 1 wherein said precursor comprises water, cobalt acetate, nickel acetate, manganese acetate, tantalum acetate, ruthenium acetate, tungsten ethoxide, cobalt nitrate, nickel nitrate, manganese nitrate in a pH adjusted solution with or without sugar.

14. The method according to claim 1 wherein said thermal spray comprises a plasma source.

15. The method according to claim 1 wherein said thermal spray comprises a combustion source.

16. The method according to claim 1 wherein said thermal spray comprises a preheated gaseous source.

17. The method according to claim 1, wherein said precursor is entirely a solution comprising an elemental source for a desired electrode compound and a carbon source.

18. The method according to claim 1, wherein said precursor is entirely a solution comprising an elemental source for a desired electrolyte compound.

19. The method according to claim 1, wherein said precursor is a slurry comprising suspended particles for a desired electrode compound and a solution.

20. The method according to claim 1, wherein said precursor is a slurry comprising suspended particles for a desired electrolyte compound and a solution.

21. The method according to claim 1, wherein said precursor is a slurry comprising suspended particles for a desired electrolyte compound and or a solution.
